(19) United States
(12) Patent Application Publication
(10) Pub. No.: US 2007/0081218 A1
(43) Pub. Date: Apr. 12, 2007

(54) LIGHT SCANNING DEVICE AND SCANNING OPTICAL SYSTEM

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/548,464

(22) Filed: Oct. 11, 2006

(30) Foreign Application Priority Data
Oct. 12, 2005 (JP) P2005-297771
Nov. 25, 2005 (JP) P2005-340874

(51) Int. Cl. G02B 26/08

(52) U.S. Cl. 359/208

(57) ABSTRACT

A light scanning device includes a polygon mirror configured to be rotatable around a rotation axis to reflect and deflect a light beam with a plurality of reflecting surfaces, a light source that makes a light beam incident onto the polygon mirror from an outside of a scanning range of the light beam being scanned in a main scanning direction by the polygon mirror, and an image forming optical system that converges the deflected light beam as a spot scanned in the main scanning direction on a scanned surface. In a state where the light beam is directed to a center of the scanning range on the scanned surface, a chief ray of the light beam intersects with a reflecting surface at a point shifted by a predetermined amount in a direction toward a side opposite the light source front a center of the reflecting surface in the main scanning direction.

### BACKGROUND OF THE INVENTION

The present invention relates to a light scanning device and a scanning optical system incorporated in a laser printer or the like that are configured to scan a laser beam on a scanned object surface, in particular, a light scanning device and a scanning optical system configured to reduce jitter in an auxiliary scanning direction.

A light scanning device (scanning optical system) incorporated in a laser printer or the like is configured such that a laser beam emitted from a light source is reflected and deflected by a deflector such as a polygon mirror, and is directed onto a scanned object surface such as a photoconductive drum via a scanning lens such as an fθ lens to provide an image as a spot thereon. The spot on the photoconductive drum is scanned in a main scanning direction accompanied by the rotation of the polygon mirror. At this time, an electrostatic latent image is formed on the scanned object surface with the laser beam being ON/OFF modulated.

Each of reflecting surfaces of the polygon mirror is desired to be parallel to a rotation axis thereof. However, it is difficult to attain the polygon mirror with each of the reflecting surfaces perfectly parallel to the rotation axis, and each of the reflecting surfaces of the polygon mirror generally has a certain level of tilt angle between the rotation axis and itself due to various kinds of manufacturing errors. Such a condition is called an “optical face tangle error”. In the light scanning device (scanning optical system), generally, optical elements of an anamorphic optical system are arranged in front and to the rear of the polygon mirror to correct a location error of the spot on the scanned object surface in the auxiliary scanning direction caused by the optical face tangle error. In other words, the laser beam emitted from the light source forms a line image in a vicinity of a reflecting surface of the polygon mirror using a cylindrical lens with a power only in the auxiliary scanning, direction. Then, the laser beam is converged again on the photoconductive drum with the anamorphic fθ lens. Thereby, the optical face tangle error is corrected such that the spot location on the photoconductive drum cannot improperly be shifted in the auxiliary scanning direction.

In the meantime, when utilizing the polygon mirror as a deflector, a deflection point (an intersection of a chief ray of the laser beam with the reflecting surface of the polygon mirror) shifts along the chief ray of the incident laser beam accompanied by the rotation of the polygon mirror. Such a shift of the deflection point is called a “deflection point shift”, and the amount of the shift is called a “deflection point shift amount”. The deflection point shift is caused by the distance from the rotation axis of the polygon mirror to each of the deflection points varying depending on a rotational position of the polygon mirror. Because of the deflection point shift, the aforementioned line image can be formed just on the reflecting surface of the polygon mirror only at each of specific rotational positions. Meanwhile, the line image cannot be formed just on each of the reflecting surfaces of the polygon mirror at each of the other rotational positions. Accordingly, in the case of the optical face tangle error, the spot location on the scanned object surface in the auxiliary scanning direction is shifted depending on that in the main scanning direction, and thereby a scanned line that should ideally be straight is improperly curved. Such an improper shift of the spot location in the auxiliary direction is called “jitter in the auxiliary scanning direction”, and the amount of the shift is called a “jitter amount”. The jitter amount in the auxiliary scanning direction is determined by a product of an orthogonal magnification of the fθ lens in the auxiliary scanning direction, an angle defined in the optical face tangle error of the reflecting surface of the polygon mirror, and the deflection point shift amount. Namely, as each value of the orthogonal magnification of the fθ lens in the auxiliary scanning direction, the angle defined in the optical face tangle error of the reflecting surface of the polygon mirror, and the deflection point shift amount gets larger, the jitter amount is increased.

It is noted that a conventional light scanning device (scanning optical system) is configured such that the laser beam is incident onto the center of the reflecting surface in the main scanning direction in a state (standard state) where the reflected laser beam is directed onto the center of the scanned object surface in order to effectively utilize the reflecting surface of the polygon mirror. According to the light scanning device (scanning optical system) configured as above, when the laser beam emitted from the light source is incident onto the polygon mirror at a slant in a main scanning plane, the deflection point shift is asymmetrically formed with respect to the deflection point in the standard state. Especially, the amount of the deflection point shift that is caused when the laser beam is scanned from the center of a scanning range to an end of the scanning range opposite to the light source side remarkably gets larger. Therefore, the jitter amount is very large at the end opposite to the light source side end, so that a drawing performance is worsened.

There is disclosed in Japanese Patent Provisional Publication No. 2004-177861 such a technique that the jitter in the auxiliary scanning direction is reduced lower than a level in which the jitter does not cause a negative effect on the drawing performance by making the size of a polygon mirror smaller than a predetermined size obtained based on parameters such as a magnification, focal length, and scanning width of an image forming optical system, using a polygon mirror having six reflecting surfaces or less

However, according to the technique disclosed in the aforementioned publication, since the size of the polygon mirror is smaller than that of a generally used one, a deflection angle range is narrower than that of the generally used polygon mirror with the same number of the reflecting surfaces. Namely, in this technique, it is needed for ensuring a certain level of scanning range to reduce the number of the reflecting surfaces, yet it makes it difficult to heighten a drawing speed.

### SUMMARY OF THE INVENTION

The present invention is advantageous in that there can be provided an improved light scanning device and an improved scanning optical system that are configured to reduce a jitter amount in an auxiliary scanning direction without making the size of a polygon mirror smaller.

According to an aspect of the present invention, there are provided a light scanning device, which includes: a polygon mirror configured to be rotatable around a predetermined rotation axis to reflect and deflect an incident light beam with a plurality of reflecting surfaces thereof; a light source configured to emit at least one light beam and make the at least one light beam emitted incident onto the polygon mirror from an outside of a scanning range of the at least one light beam being scanned in a main scanning direction by the polygon mirror; and an image forming optical system configured to converge the at least one light beam deflected by the polygon mirror as a spot scanned in the main scanning direction on a scanned object surface. In a standard state where the at least one light beam is directed to a center of the scanning range on the scanned object surface, a chief ray of the at least one light beam intersects with each of the plurality of reflecting surfaces at a point shifted by a predetermined shift amount in a direction toward a side opposite the light source from a center of each of the plurality of reflecting surfaces in the main scanning direction such that jitter amounts in an auxiliary scanning direction perpendicular to the main scanning direction at both ends of the scanning range on the scanned object surface are substantially identical.

Optionally, when an angle between an incident light beam from the light source and a reflected light beam from the polygon mirror in the standard state is represented by a [degrees], a deflection angle between the reflected light beam from the polygon mirror in the standard state and a reflected beam directed to a maximum image height is represented by θMAX [degrees], an inscribed radius of the polygon mirror is represented by R [mm], and the shift amount is represented by δ [mm], a condition (1) shown below may be satisfied:
0.5≦δ/(R×tan(θ_{MAX}/4)×tan(θ_{MAX}/2)×tan(α/2))≦2 (1)

Optionally, the light source may emit a plurality of light beams independently modulated. In this case, the jitter amounts in the auxiliary scanning direction at both ends of the scanning range on the scanned object surface may be substantially identical for each of the plurality of light beams.

Further optionally, the chief rays of the plurality of light beams may be incident onto a single point on each of the plurality of reflecting surfaces at a predetermined rotational position of the polygon mirror.

Still optionally, the light source may include a cylindrical lens having a power in the auxiliary scanning direction. In this case, the plurality of light beams may be converged in the auxiliary scanning direction by the cylindrical lens to form a line image in a vicinity of each of the plurality of reflecting surfaces.

According to another aspect of the present invention, there is provided a scanning optical system, which includes: a polygon mirror configured to be rotatable around a predetermined rotation axis to reflect and deflect an incident light beam with a plurality of reflecting surfaces thereof; a light source configured to emit at least one light beam and make the at least one light beam emitted incident onto the polygon mirror from an outside of a scanning range of the at least one light beam being scanned in a main scanning direction by the polygon mirror; and an image forming optical system configured to converge the at least one light beam deflected by the polygon mirror as a spot scanned in the main scanning direction on a scanned object surface. In a standard state where the at least one light beam is directed to a center of the scanning range on the scanned object surface, a chief ray of the at least one light beam intersects with each of the plurality of reflecting surfaces at a point shifted by a predetermined shift amount in a direction toward a side opposite the light source from a center of each of the plurality of reflecting surfaces in the main scanning direction such that jitter amounts in an auxiliary scanning direction perpendicular to the main scanning direction at both ends of the scanning range on the scanned object surface are substantially identical.

According to a further aspect of the present invention, there is provided a light scanning device, which includes: a polygon mirror configured to be rotatable around a predetermined rotation axis to reflect and deflect an incident light beam with a plurality of reflecting surfaces thereof; a light source configured to emit at least one light beam and make the at least one light beam emitted incident onto the polygon mirror from an outside of a scanning range of the at least one light beam being scanned in a main scanning direction by the polygon mirror; and an image forming optical system configured to converge the at least one light beam deflected by the polygon mirror as a spot scanned in the main scanning direction on a scanned object surface. A position on each of the plurality of reflecting surfaces at which a chief ray of the at least one light beam intersects with each of the plurality of reflecting surfaces is adjusted such that a jitter amount in an auxiliary scanning direction perpendicular to the main scanning direction can be reduced over the scanning range on the scanned object surface.

According to a further aspect of the present invention, there is provided a scanning optical system, which includes: a polygon mirror configured to be rotatable around a predetermined rotation axis to reflect and deflect an incident light beam with a plurality of reflecting surfaces thereof; a light source configured to emit at least one light beam and make the at least one light beam emitted incident onto the polygon mirror from an outside of a scanning range of the at least one light beam being scanned in a main scanning direction by the polygon mirror; and an image forming optical system configured to converge the at least one light beam deflected by the polygon minor as a spot scanned in the main scanning direction on a scanned object surface. A position on each of the plurality of reflecting surfaces at which a chief ray of the at least one light beam intersects with each of the plurality of reflecting surfaces is adjusted such that a jitter amount in an auxiliary scanning direction perpendicular to the main scanning direction can be reduced over the scanning range on the scanned object surface.

### BRIEF DESCRIPTION OF THE ACCOMPANYING DRAWINGS

FIG. 1 is a top view in a main scanning plane showing arrangements of optical elements included in a light scanning device (scanning optical system) according to an embodiment of the present invention.

FIG. 2 schematically shows a positional relationship between an incident laser beam and a polygon mirror in the light scanning device (scanning optical system) according to the embodiment of the present invention.

FIG. 3 is an enlarged view of a portion of a configuration shown in FIG. 2.

FIGS. 4A and 4B show relationships between an image height and a jitter amount in an auxiliary scanning direction for laser beams emitted from different semiconductor lasers of the light scanning device (scanning optical system) according to the embodiment of the present invention, respectively.

FIGS. 5A and 5B show relationships between the image height and the jitter amount in the auxiliary scanning direction for laser beams with different incident angles in a comparative example, respectively.

FIG. 6 is a top view in a main scanning plane showing arrangements of optical elements included in a light scanning device (scanning optical system) according to a modification of the present invention.

### DETAILED DESCRIPTION OF THE EMBODIMENTS

Hereinafter, embodiments of a light scanning device (scanning optical system) according to the present invention will be explained with reference to the accompanying drawings.

A light scanning device in an embodiment, which is used as a laser scanning unit (LSU) of the laser printer, is configured to scan a laser beam that is ON/OFF modulated in accordance with an inputted drawing signal on a scanned object surface such as a photoconductive drum and form an electrostatic latent image. In this specification, a direction in which a spot is scanned on the scanned object surface is defined as a main scanning direction, and a direction perpendicular to the main scanning direction is defined as an auxiliary scanning direction. In addition, explanations about directions of a shape and power of each optical element will be made based on the directions on the scanned object surface. A plane that is parallel to the main scanning direction and includes an optical axis of an image forming optical system is defined as a main scanning plane.

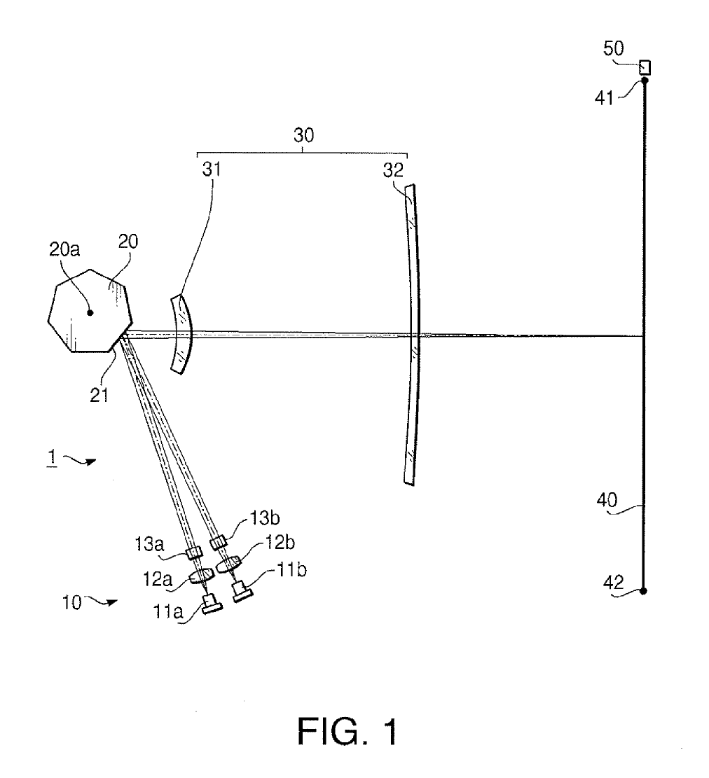

As shown in FIG. 1 that is a top view in the main scanning plane, a light scanning device (scanning optical system) 1 in the embodiment is configured such that a laser beam emitted from a light source 10 is reflected and deflected by a polygon mirror 20, and is then converged as a spot on a scanned object surface 40 with an fθ lens as an image forming optical system.

The light source 10 is provided with two semiconductor lasers 11a and 11b, collimating lenses 12a and 12b, which make diverging laser beams emitted from the semiconductor lasers 11a and 11b collimated, respectively, and cylindrical lenses 13a and 13b having positive powers in the auxiliary scanning direction. Further, the light source 10 is configured such that the two laser beams modulated independently from one another are incident onto the polygon mirror 20 from the outside of a scanning range of the laser beams reflected by the polygon mirror 20. As shown in FIG. 1, there is a predetermined angle difference between the two laser beams in the main scanning direction, and further a small angle difference therebetween in the auxiliary scanning direction.

The polygon mirror 20 has seven reflecting surfaces 21, and is configured to be rotatable in the clockwise direction in FIG. 1 around a rotation axis 20a perpendicular to the main scanning plane. The fθ lens 30 is provided with a first scanning lens 31 arranged in the vicinity of the polygon mirror 20 and a second scanning lens 32 arranged at the side of the scanned object surface 40. Both of the first and second scanning lenses are plastic lenses.

Each of the laser beams, emitted from the semiconductor lasers 11a and 11b and collimated by the collimating lenses 12a and 12b, respectively, forms a line image in the vicinity of the polygon mirror 20 via the cylindrical lens 13a or 13b.

The laser beams reflected by the polygon mirror 20 are incident onto the fθ lens 30 as laser beams substantially collimated in the main scanning direction as shown in FIG. 1 and diverging in the auxiliary scanning direction. The laser beams transmitted through the fθ lens 30 form two spots separated in the main and auxiliary scanning directions on the scanned object surface 40. The two spots are scanned from a starting end 41 to a terminating end 42 on the scanned object surface 40 in the main scanning direction accompanied by the rotation of the polygon mirror 20. At this time, two scanned lines are simultaneously formed with the semiconductor lasers 11a and 11b being modulated.

It is noted that there is provided short of the starting end 41 of the scanned object surface 40 in the main scanning direction a light detecting sensor 50 for obtaining a synchronizing signal for modulation.

The aforementioned light scanning device (scanning optical system) 1 is configured such that a chief ray of each of the two laser beams intersects with the reflecting surface 21 at a position thereon that is shifted by a predetermined distance from the center of the reflecting surface 21 in the main scanning direction toward a side opposite the light source 10 in a standard state where each of the two laser beams is directed onto the center of the scanning range on the scanned object surface 40. Thereby, the jitter amounts in the auxiliary direction at both of the ends in the scanning range are almost made identical. It is noted that a projected image of the chief ray of a reflected laser beam in the standard state on the main scanning plane coincides with an optical axis of the in lens.

Specifically, when an angle between an incident beam from the light source 10 and the reflected beam from the polygon mirror 20 in the standard state is represented by a [degrees], a deflection angle between the reflected beam from the polygon mirror 20 in the standard state and a reflected beam directed to the maximum image height is represented by θ_{MAX} [degrees], an inscribed radius of the polygon mirror 20 is represented by R [mm], and the shift amount is represented by δ [mm], a condition (1) shown below is satisfied for each of the laser beams.
0.5≦δ/(R×tan(θ_{MAX}/4)×tan(θ_{MAX}/2)×tan(α/2))≦2 (1)

In addition, the two laser beams are configured such that the chief ray of each of the laser beams is incident onto a single point on the reflecting surface 21 at a predetermined rotational position of the polygon mirror 20. Thereby, a tilt of an image plane in the auxiliary scanning direction is appropriately corrected. In the below-mentioned design in the embodiment, the chief rays of the two laser beams are incident onto a single point on the reflecting surface 21 at two rotational positions of 48.4 degrees and 65 degrees on the basis of a state where the reflecting surface 21 is parallel to the optical axis of the fθ lens.

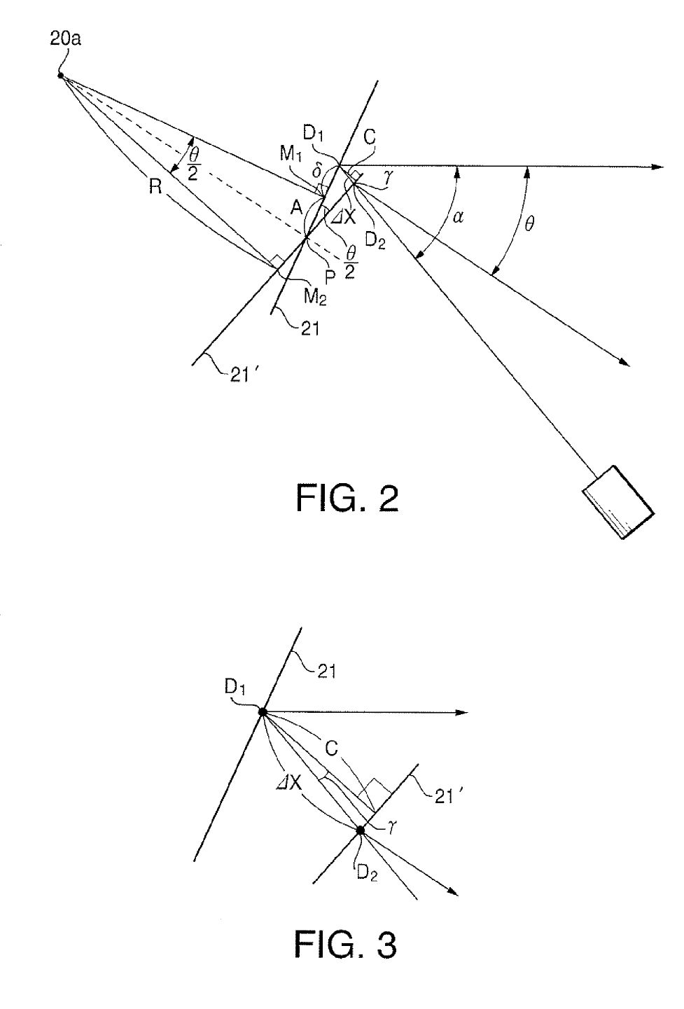

Next, it will be explained how the condition (1) is derived, based on FIG. 2 and FIG. 3 that is an enlarged view of a portion of a configuration shown in FIG. 2. Here, it will be explained to take a single laser beam as an example.

As shown in FIG. 2, the chief ray of the laser beam incident onto the polygon mirror 20, in the standard state, intersects with the reflecting surface 21 at a position shifted by the shift amount δ in a direction toward a side opposite the light source 10 with respect to a center M₁ of the reflecting surface 21 in the main scanning direction. Here, a reflecting surface of the polygon mirror 20 in the standard state is denoted by a reference sign 21, while a reflecting surface in a state where the polygon mirror 20 has been rotated by θ/2 degrees with respect to the standard state is denoted by a reference sign 21′. In addition, centers (intersections of the reflecting surfaces 21 and 21′ with an inscribed circle) of the reflecting surfaces 21 and 21′ in the main scanning direction are denoted by reference signs M₁ and M₂, respectively. Deflection points on the reflecting surfaces 21 and 21′ are denoted by reference signs D₁ and D₂, respectively. An intersection of both of the reflecting surfaces 21 and 21′ is denoted by a reference sign P. An angle (deflection angle) between a reflected beam in the standard state and a reflected beam in the state where the polygon mirror 20 has been rotated by θ/2 degrees with respect to the standard state is θ degrees.

As shown in FIG. 3 as well, when the length of a perpendicular line dropped from the deflection in the standard state to the reflecting surface 21′ in the state where the polygon mirror 20 has been rotated by θ/2 with respect to the standard state is represented by C, the angle between the perpendicular line and the chief ray of the incident beam is represented by γ, and the distance between the points M₁ and P is represented by A, a deflection point shift amount ΔX(θ) cant be expressed by the following equation (2):

$$Δ X ( θ ) = \frac{C}{cos γ} \qquad ( 2 )$$

It is noted that C, A, and γ are represented as follows;

$$C = ( A + δ ) sin \frac{θ}{2}$$

$$A = R tan \frac{θ}{4}$$

$$γ = \frac{θ}{2} - \frac{α}{2} .$$

By applying the above C, A, and γ to the equation (2), the following equation (3) is derived:

$$Δ X ( θ ) = \frac{( R tan \frac{θ}{4} + δ ) sin \frac{θ}{2}}{cos ( \frac{θ}{2} - \frac{α}{2} )} \qquad ( 3 )$$

The scanning range is divided into two areas on the basis of the optical axis of the fθ lens as a border, and one of the two areas at an opposite side to the light source 10 is defined as an area of negative image height, while the other at the light source side is defined as an area of positive image height. Regarding the deflection angle, the positive and negative signs are given thereto in a similar fashion. When the deflection angle of a laser beam converged on the starting end 41 is represented by −θ_{MAX}, the deflection angle of a laser beam converged on the terminating end 42 can be expressed by +θ_{MAX}. Accordingly, the amounts of jitters caused by the deflection point shift at both of the ends can be made equal with the following equation being satisfied:
ΔX(θ_{MAX})−ΔX(−θ_{MAX})=0

When the equation (3) is applied to the above equation, the following equation (4) is obtained. Further, the equation (4) can be converted into an equation (5) such that the sign of the deflection angle “−θ_{MAX}” in the equation (4) is changed to positive one.

$$\begin{matrix}\frac{( R tan \frac{{θ}_{MAX}}{4} + δ ) sin \frac{{θ}_{MAX}}{2}}{cos ( \frac{{θ}_{MAX}}{2} - \frac{α}{2} )} - \frac{( R tan \frac{- {θ}_{MAX}}{4} + δ ) sin \frac{- {θ}_{MAX}}{2}}{cos ( \frac{- {θ}_{MAX}}{2} - \frac{α}{2} )} = 0 & ( 4 ) \\ \frac{( R tan \frac{{θ}_{MAX}}{4} + δ ) sin \frac{{θ}_{MAX}}{2}}{cos ( \frac{{θ}_{MAX}}{2} - \frac{α}{2} )} + \frac{( - R tan \frac{{θ}_{MAX}}{4} + δ ) sin \frac{{θ}_{MAX}}{2}}{cos ( \frac{{θ}_{MAX}}{2} + \frac{α}{2} )} = 0 & ( 5 )\end{matrix}$$

The denominators in the equation (5) can be expanded with the addition theorem as follows:

$$cos ( \frac{{θ}_{MAX}}{2} - \frac{α}{2} ) = cos \frac{{θ}_{MAX}}{2} cos \frac{α}{2} + sin \frac{{θ}_{MAX}}{2} sin \frac{α}{2}$$

$$cos ( \frac{{θ}_{MAX}}{2} + \frac{α}{2} ) = cos \frac{{θ}_{MAX}}{2} cos \frac{α}{2} - sin \frac{{θ}_{MAX}}{2} sin \frac{α}{2}$$

When the products of the cosines and the sines in the aforementioned equations are defined by “a” and “b”, respectively, the denominators of the terms in the equation (5) can be represented by “a+b” and “a−b”, respectively. Namely, the equation (5) can be expressed as the following equation (6):

$$\frac{( R tan \frac{{θ}_{MAX}}{4} + δ ) sin \frac{{θ}_{MAX}}{2}}{a + b} + \frac{( - R tan \frac{{θ}_{MAX}}{4} + δ ) sin \frac{{θ}_{MAX}}{2}}{a - b} = 0 \qquad ( 6 )$$

The equation (6) is converted into an equation (7) to solve for δ as follows:

$$( a - b ) ( R tan \frac{{θ}_{MAX}}{4} + δ ) + ( a + b ) ( - R tan \frac{{θ}_{MAX}}{4} + δ ) = 0 \\ δ = \frac{b R tan \frac{{θ}_{MAX}}{4}}{a} \qquad ( 7 )$$

By restoring “a” and “b” to the respective original expressions, an equation (8) can be obtained.

$$\begin{matrix}δ = \frac{R sin \frac{{θ}_{MAX}}{2} sin \frac{α}{2} tan \frac{{θ}_{MAX}}{4}}{cos \frac{{θ}_{MAX}}{2} cos \frac{α}{2}} \\ δ = R tan \frac{{θ}_{MAX}}{4} tan \frac{{θ}_{MAX}}{2} tan \frac{α}{2}\end{matrix} \qquad ( 8 )$$

When the equation (8) is satisfied, the jitter amounts at both of the starting end 41 and terminating end 42 can be made identical. However, even though the both cannot perfectly be made identical, when a ratio of the left side to the right side of the equation (8) is within a range of 0.5 to 2.0, the jitter can be reduced. Therefore, the light scanning device (scanning optical system) 1 in the embodiment is designed to satisfy the aforementioned condition (1).

Next, a concrete configuration of the light scanning device (scanning optical system) 1 in the embodiment will be explained. In the embodiment, a first surface of the first scanning lens 31 at the polygon mirror 20 side is a concave spherical surface, and a second surface thereof at the scanned object surface 40 side is a convex aspheric surface of rotational symmetry. In addition, a first surface of the second scanning lens 32 at the polygon mirror 20 side is a concave aspheric surface of rotational symmetry, and a second surface thereof at the scanned object surface 40 side is an anamorphic aspheric surface.

The shape of the aspheric surface of rotational symmetry is represented by a sag amount X(h) from a tangent plane at an intersection of the optical axis with the aspheric surface at a distance “h” from the optical axis. The sag amount X(h) is expressed by the following equation:

$$X ( h ) = \frac{{h}^{2}}{[ r \{ 1 + \sqrt{( 1 - ( κ + 1 ) {h}^{2} / {r}^{2}} \} ]} + {A}_{4} {h}^{4} + {A}_{6} {h}^{6}$$

In the above equation, r represents a curvature radius on the optical axis, Kr represents a conical coefficient, and A4 and A6 represent fourth and sixth order aspheric coefficients, respectively.

In addition, the anamorphic aspheric surface is an aspheric surface without a rotation axis, of which a curvature radius at a position off the optical axis in the auxiliary scanning direction is configured independently of a cross-sectional shape of the aspheric surface in the main scanning direction. When the curvature radius on the optical axis in the main scanning direction is represented by “ry₀”, the conical coefficient is represented by “κ”, an n-th order aspheric coefficient in the main scanning direction is represented by “AMₙ”, a curvature radius on the optical axis in the auxiliary scanning direction at each position y in the main scanning direction is represented by “rz₀”, and an n-th order aspheric coefficient in the auxiliary direction is represented by “ASₙ”, the cross-sectional shape X(y) in the main scanning direction and the curvature radius rz(y) in the auxiliary scanning direction can be obtained from the following equations, respectively,

$$\begin{matrix}X ( y ) = \frac{{y}^{2}}{{ry}_{0 } ( 1 + \sqrt{1 - \frac{( κ + 1 ) {y}^{2}}{{ry}_{0}^{2}}} )} + {\sum }_{i = 4}^{8} {AM}_{i} \cdot {y}^{i} \\ \frac{1}{rz ( y )} = \frac{1}{{rz}_{0}} + {\sum }_{i = 1}^{8} {AS}_{i} \cdot {y}^{i}\end{matrix}$$

A concrete numerical specification of the light scanning device (scanning optical system) in the embodiment is shown in Table 1. In Table 1, a reference sign “ry” represents the curvature radius (unit: mm) of each optical element in the main scanning direction, a reference sign “rz” represents the curvature radius in the auxiliary scanning direction (which is omitted in case of a surface of rotational symmetry, unit: mm), a reference sign “d” represents the distance between surfaces on the optical axis (unit: mm), and a reference sign “nλ” represents the refractive index at a design wavelength. In this example, the design wavelength is 780 nm.

TABLE 1
Polygon mirror inscribed radius R = 15.14 mm
Number of polygon surfaces: 7, Design wavelength: 780 nm

| Surface | | | | | |
|---|---|---|---|---|---|
| Number | ry | rz | d | nλ | Optical Element |
| 1 | ∞ | 51.08 | 4.00 | 1.51072 | Cylindrical Lens |
| 2 | ∞ | — | 97.00 | | |
| 3 | ∞ | — | 24.00 | | Polygon Mirror |
| 4 | −65.20 | — | 6.40 | 1.48617 | First Scanning Lens |
| 5 | −40.00 | — | 104.00 | | |
| 6 | −400.00 | — | 3.20 | 1.48617 | Second Scanning |
| | | | | | Lens |
| 7 | −1600.00 | −27.52 | 106.60 | | |
| 8 | ∞ | — | — | | Scanned Object |
| | | | | | Surface |

Values of the conical coefficients and aspheric coefficients that define aspheric surfaces of rotational symmetry for the fifth and sixth surfaces are shown in Tables 2 and 3, respectively. Values of the conical coefficient and aspheric coefficient that define an anamorphic aspheric surface for the seventh surface are shown in Tables 4.

TABLE 2
Fifth surface (aspheric surface of rotational symmetry)

| | |
|---|---|
| κ | 0.00000 |
| A₄ | 4.88072 × 10⁻⁰⁷ |
| A₆ | 0.00000 |

TABLE 3
Sixth surface (aspheric surface of rotational symmetry)

| | |
|---|---|
| κ | 0.00000 |
| A₄ | 1.98405 × 10⁻⁰⁸ |
| A₆ | 0.00000 |

TABLE 4
Seventh surface (anamorphic aspheric surface)

| | | | |
|---|---|---|---|
| κ | 0.0000 | | |
| AM₁ | 0.0000 | AS₁ | 2.4150 × 10⁻⁰⁶ |
| AM₂ | 0.0000 | AS₂ | 2.5935 × 10⁻⁰⁶ |
| AM₃ | 0.0000 | AS₃ | −8.6023 × 10⁻¹⁰ |
| AM₄ | 5.5205 × 10⁻⁰⁸ | AS₄ | −2.7362 × 10⁻¹⁰ |
| AM₅ | 0.0000 | AS₅ | 1.3616 × 10⁻¹⁰ |
| AM₆ | −7.0565 × 10⁻¹² | AS₁₀ | 0.0000 |
| AM₇ | 0.0000 | AS₁₂ | 0.0000 |

An actual drawing range of the light scanning device (scanning optical system) 1 in the embodiment is image heights of −120 mm to 120 mm. However, since the image height of the light detecting sensor 50 is −130 mm, the light scanning device (scanning optical system) 1 is configured such that the deflection point shifts at both ends of image heights of −130 mm to 130 mm are substantially the same.

A rotational angle difference (θ_{MAX}/2) of the polygon mirror 20 between a state where the reflected beam is directed to the light detecting sensor 50 and the standard state is 17.242 degrees. In addition, the angle ca for the chief ray of the laser beam emitted from the first semiconductor laser 11a is 72 degrees, while the angle α for the chief ray of the laser beam emitted from the second semiconductor laser 11b is 66 degrees. The deflection point shift amount δ in the standard state is 1.003 mm for the laser beam emitted from the first semiconductor laser 11a, and 0.233 mm for the laser beam emitted from the second semiconductor laser 11b.

With each value of θ_{MAX}/2=17.242 degrees, R=15.14 mm, α=72 or 66 degrees, and δ=1.003 or 0.233 mm being applied to the middle portion of the condition (1), the middle portion of the condition (1) is calculated as follows:

for the laser beam emitted from the first semiconductor laser 11a

$$\begin{matrix}\frac{δ}{( \begin{matrix}R \times tan ( \frac{ {θ}_{ MAX}}{ 4} ) \times \\ tan ( \frac{ {θ}_{ MAX}}{ 2} ) \times tan ( \frac{α}{ 2} )\end{matrix} )} = \frac{1.003}{\begin{matrix}( 15.14 \times tan ( 8.621 ° ) \times \\ tan ( 17.242 ° ) \times tan ( 36 ° )\end{matrix}} \\ = \frac{1.003}{0.518} \\ = 1.936\end{matrix}$$

for the laser beam emitted front the second semiconductor laser 11b,

$$\begin{matrix}\frac{δ}{( \begin{matrix}R \times tan ( \frac{ {θ}_{ MAX}}{ 4} ) \times \\ tan ( \frac{ {θ}_{ MAX}}{ 2} ) \times tan ( \frac{α}{ 2} )\end{matrix} )} = \frac{0.233}{\begin{matrix}( 15.14 \times tan ( 8.621 ° ) \times \\ tan ( 17.242 ° ) \times tan ( 33 ° )\end{matrix}} \\ = \frac{0.233}{0.463} \\ = 0.503\end{matrix}$$

Both of the above two values satisfy the condition (1).

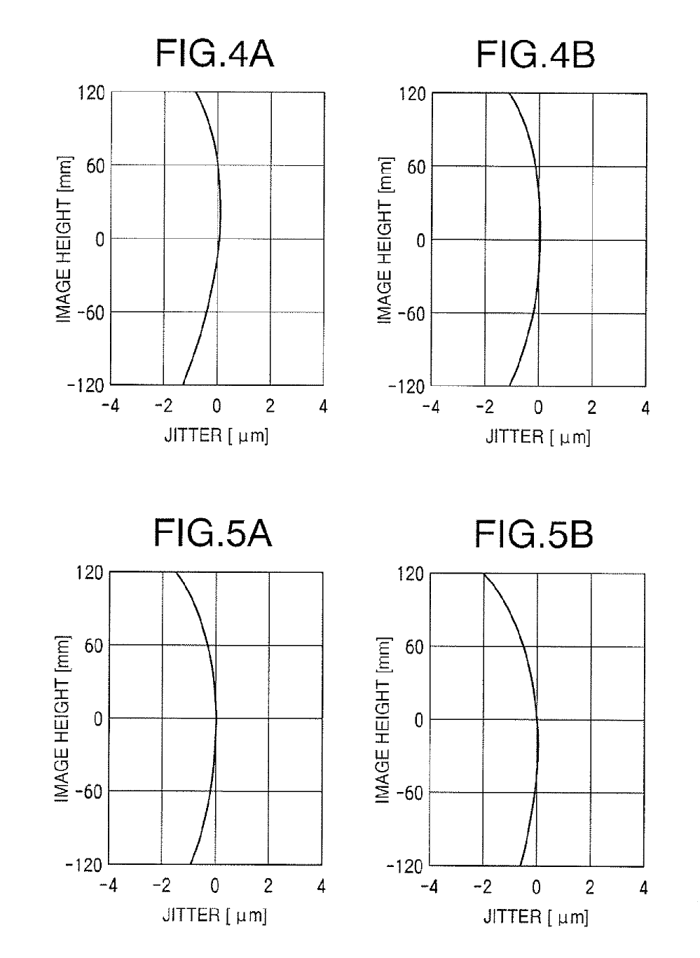

FIG. 4A shows a relationship between the image height and the jitter in the auxiliary scanning direction for the laser beam emitted from the first semiconductor laser 11a of the light scanning device (scanning optical system) 1 in the embodiment. FIG. 4B shows a relationship between the image height and the jitter in the auxiliary scanning direction for the laser beam emitted from the second semiconductor laser 11b. In both of FIGS. 4A and 4B, the horizontal axis represents the jitter amount (unit: μm), and the vertical axis represents the image height y (unit: mm). A fluctuation range of the jitter amount is controlled by 1.5 μm or less in any case. In addition, the characteristics of the jitter occurrence for both of the laser beams are controlled uniform.

In the meantime, FIGS. 5A and 5B show jitter characteristics in a comparative example where a light scanning device (scanning optical system), which has a similar configuration to the embodiment, is designed such that a chief ray of an incident laser beam is incident onto the center of the reflecting surface of the polygon mirror in the main scanning direction in the standard state. FIG. 5A show a relationship between the image height and the jitter for the laser beam incident onto the polygon mirror with an angle of 72 degrees with respect to the optical axis of the fθ lens, while FIG. 5B show a relationship between the image height and the jitter for the laser beam incident onto the polygon mirror with an angle of 66 degrees with respect to the optical axis of the fθ lens. Particularly, in the case of an angle of 66 degrees, the jitter characteristics show large asymmetry, and the fluctuation range of the jitter amount reaches up to 2.0 μm. Further, the characteristics of the jitter occurrence are different between the cases of angles of 72 degrees and 66 degrees.

As clarified in comparison between FIGS. 4 and 5, the light scanning device (scanning optical system) 1 in the embodiment, which is configured such that the chief ray of the laser beam intersects with the reflecting surface 21 at a position shifted by a predetermined shift amount in a direction to the opposite side to the light source 10 front the center of the reflecting surface 21 in the main scanning direction, can suppress the maximum value of the jitter, so as to reduce the curvature of the scanned line, and to make the characteristics of the jitter occurrence uniform between the laser beams with different incident angles. Thereby, the light scanning device (scanning optical system) 1 in the embodiment can attain higher drawing accuracy and less drawing non-uniformity than that in the comparative example can.

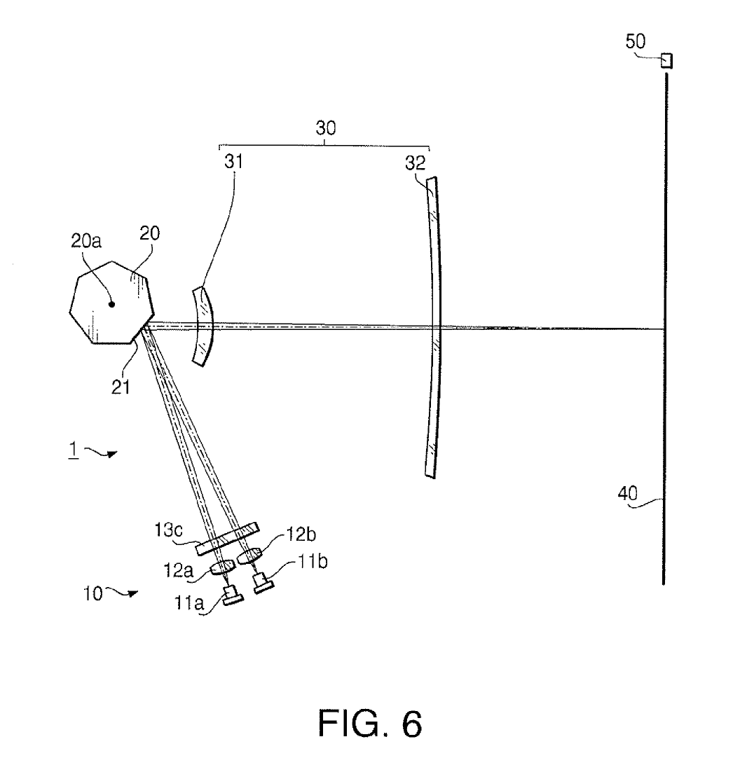

FIG. 6 is a top view in the main scanning plane of a modification of the light scanning device (scanning optical system) 1 shown in FIG. 1. In the modification shown in FIG. 6, two laser beams emitted from a light source 10 are transmitted through a single cylindrical lens 13c to be incident onto a polygon mirror 20. Thus, by using the cylindrical lens in common for the two laser beams, the number of components of the light scanning device (scanning optical system) can be more reduced than that of the light scanning device (scanning optical system) 1 shown in FIG. 1 so that the overall configuration can be more simplified.

The present disclosure relates to the subject matters contained in Japanese Patent Applications No. P2005-297771 and No. P2005-340874, filed on Oct. 12, 2005, and Nov. 25, 2005, respectively, which are expressly incorporated herein by reference in their entirety.

What is claimed is:

1. A light scanning device, comprising:
a polygon mirror configured to be rotatable around a predetermined rotation axis to reflect and deflect an incident light beam with a plurality of reflecting surfaces thereof;
a light source configured to emit at least one light beam and make the at least one light beam emitted incident onto the polygon mirror from an outside of a scanning range of the at least one light beam being scanned in a main scanning direction by the polygon mirror; and
an image forming optical system configured to converge the at least one light beam deflected by the polygon mirror as a spot scanned in the main scanning direction on a scanned object surface,
wherein, in a standard state where the at least one light beam is directed to a center of the scanning range on the scanned object surface, a chief ray of the at least one light beam intersects with each of the plurality of reflecting surfaces at a point shifted by a predetermined shift amount in a direction toward a side opposite the light source from a center of each of the plurality of reflecting surfaces in the main scanning direction such that jitter amounts in an auxiliary scanning direction perpendicular to the main scanning direction at both ends of the scanning range on the scanned object surface are substantially identical.

2. The light scanning device according to claim 1,
wherein a condition (1) shown below is satisfied:
0.5≦δ/(R×tan(θ_{MAX}/4)×tan(θ_{MAX}/2)×tan(α/2))≦2 (1)
when an angle between an incident light beam from the light source and a reflected light beam from the polygon mirror in the standard state is represented by α [degrees], a deflection angle between the reflected light beam from the polygon mirror in the standard state and a reflected beam directed to a maximum image height is represented by θ_{MAX} [degrees], an inscribed radius of the polygon mirror is represented by R [mm], and the shift amount is represented by δ [mm].

3. The light scanning device according to claim 1,
wherein the light source emits a plurality of light beams independently modulated, and
wherein the jitter amounts in the auxiliary scanning direction at both ends of the scanning range on the scanned object surface are substantially identical for each of the plurality of light beams.

4. The light scanning device according to claim 3,
wherein the chief rays of the plurality of light beams are incident onto a single point on each of the plurality of reflecting surfaces at a predetermined rotational position of the polygon mirror.

5. The light scanning device according to claim 3,
wherein the light source comprises an anamorphic lens having a power in the auxiliary scanning direction, and
wherein the plurality of light beams are converged in the auxiliary scanning direction by the anamorphic lens to form a line image in a vicinity of each of the plurality of reflecting surfaces.

6. A scanning optical system, comprising:
a polygon mirror configured to be rotatable around a predetermined rotation axis to reflect and deflect an incident light beam with a plurality of reflecting surfaces thereof;
a light source configured to emit at least one light beam and make the at least one light beam emitted incident onto the polygon mirror from an outside of a scanning range of the at least one light beam being scanned in a main scanning direction by the polygon mirror; and
an image forming optical system configured to converge the at least one light beam deflected by the polygon mirror as a spot scanned in the main scanning direction on a scanned object surface,
wherein, in a standard state where the at least one light beam is directed to a center of the scanning range on the scanned object surface, a chief ray of the at least one light beam intersects with each of the plurality of reflecting surfaces at a point shifted by a predetermined shift amount in a direction toward a side opposite the light source from a center of each of the plurality of reflecting surfaces in the main scanning direction such that jitter amounts in an auxiliary scanning direction perpendicular to the main scanning direction at both ends of the scanning range on the scanned object surface are substantially identical.

7. The scanning optical system according to claim 6.
wherein a condition (1) shown below is satisfied;
0.5≦δ/(R×tan(θ_{MAX}/4)×tan(θ_{MAX}/2)×tan(α/2)≦2 (1),
when an angle between an incident light beam from the light source and a reflected light beam from the polygon mirror in the standard state is represented by α [degrees], a deflection angle between the reflected light beam from the polygon mirror in the standard state and a reflected beam directed to a maximum image height is represented by θ_{MAX} [degrees], an inscribed radius of the polygon mirror is represented by R [mm], and the shift amount is represented by δ [mm].

8. The scanning optical system according to claim 6,
wherein the light source emits a plurality of light beams independently modulated, and
wherein the jitter amounts in the auxiliary scanning direction at both ends of the scanning range on the scanned object surface are substantially identical for each of the plurality of light beams.

9. The scanning optical system according to claim 8,
wherein the chief rays of the plurality of light beams are incident onto a single point on each of the plurality of reflecting surfaces at a predetermined rotational position of the polygon mirror.

10. The scanning optical system according to claim 8.
wherein the light source comprises a anamorphic lens having a power in the auxiliary scanning direction, and
wherein the plurality of light beams are converged in the auxiliary scanning direction by the anamorphic lens to form a line image in a vicinity of each of the plurality of reflecting surfaces.

11. A light scanning device, comprising:
a polygon mirror configured to be rotatable around a predetermined rotation axis to reflect and deflect an incident light beam with a plurality of reflecting surfaces thereof;
a light source configured to emit at least one light beam and make the at least one light beam emitted incident onto the polygon mirror from an outside of a scanning range of the at least one light beam being scanned in a main scanning direction by the polygon mirror; and
an image forming optical system configured to converge the at least one light beam deflected by the polygon mirror as a spot scanned in the main scanning direction on a scanned object surface,
wherein a position on each of the plurality of reflecting surfaces at which a chief ray of the at least one light beam intersects with each of the plurality of reflecting surfaces is adjusted such that a jitter amount in an auxiliary scanning direction perpendicular to the main scanning direction can be reduced over the scanning range on the scanned object surface.

12. A scanning optical system, comprising:
a polygon mirror configured to be rotatable around a predetermined rotation axis to reflect and deflect an incident light beam with a plurality of reflecting surfaces thereof;
a light source configured to emit at least one light beam and make the at least one light beam emitted incident onto the polygon mirror from an outside of a scanning range of the at least one light beam being scanned in a main scanning direction by the polygon mirror; and
an image forming optical system configured to converge the at least one light beam deflected by the polygon mirror as a spot scanned in the main scanning direction on a scanned object surface,
wherein a position on each of the plurality of reflecting surfaces at which a chief ray of the at least one light beam intersects with each of the plurality of reflecting surfaces is adjusted such that a jitter amount in an auxiliary scanning direction perpendicular to the main scanning direction can be reduced over the scanning range on the scanned object surface.
